(19) United States
(12) Patent Application Publication
(10) Pub. No.: US 2009/0309319 A1
(43) Pub. Date: Dec. 17, 2009

(54) Stairclimbing and Descending Hand Truck

(75) Inventors: Steven Kamara, Princeton, NJ (US); Michael Yang, Princeton, NJ (US)

Correspondence Address: Saul Ewing LLP (Philadelphia), Attn: Patent Docket Clerk, 2 North Second St., Harrisburg, PA, 17101, US

(73) Assignee: SterraClimb LLC, Princeton, NJ (US)

(21) Appl. No.: 12/281,864

(22) PCT Filed: Mar. 6, 2006
(86) PCT No.: PCT/US06/07927

§ 371 Date: Jan. 8, 2009

(51) Int. Cl. B62B 5/02

(52) U.S. Cl. 280/5.26

(57) ABSTRACT

A towing device comprising a power-assisted spider wheel assembly for ascending and descending stairwells is capable of avoiding unintentional back turning hazards that may result while descending shallower stairwells by applying torque alternatively in the climb-down and climb-up direction to the spider assembly responsive to the angle formed between the spider assembly and lower stair riser. This ensures that the unit will not suddenly fall to a lower tread, which results if the lower-leaning wheel is not first pinned against the lower inside riser and rolls forward instead. The torque exerting means may also lock said spider assembly in a fixed arbitrary orientation during ascent and descent to allow the spider assembly to achieve a safe orientation before stopping mid-stairwell increasing safety.

### BACKGROUND OF THE INVENTION

1. Field of the Invention

This invention relates to a power assisted stair climbing vehicle employing a “cluster,” “X,” “Y,” “spider,” or “wheel-over-wheel” assembly for use in transporting heavy objects up and down stairs.

2. Description of the Related Art

Devices that employ “spider wheels,” “cluster wheels,” or “wheel over wheel,” mechanisms for stair climbing are known. There are numerous stair climbing vehicle designs that utilize a multiple-armed wheel-supporting spider driven in rotation so as to place rotatively supposed wheels located near the ends of the arms successively on wheel-supporting surfaces such as a flight of stairs. These devices utilize small, freely-rotating wheels fastened at the ends of spokes that rotate all together as a rigid assembly. PCT Patent Publication No. WO8600587A1 describes a stair-climbing hand truck utilizing rotating spider wheels.

Such devices have been known to employ various braking mechanisms during stairwell descent. U.S. Pat. No. 4,109,740 describes a hand truck which includes a mechanical sensor to detect when the truck is about to go down the stairs and applies a mechanically interconnected brake. Canadian Patent 877,732 describes employing an electrically-powered motor for braking.

The state of the art, however, fails to address a critical safety issue during stairwell descent likely to happen on stairwells with a shallower rise. During stairwell descent, the spider assembly rotates continuously in the down-stairs direction, placing each of the individual spider wheels successively on each lower stair riser in a controlled manner. The spider, though, may unintentionally reverse rotation direction during descent if the lower-leaning wheel of the assembly does not become properly pinned against the inside corner of the lower riser. In such a case, weight is not properly shifted to the lower leaning wheel, allowing the lower leaning wheel to roll forward rather than remain anchored as a pivot against the inside corner of the lower stair riser. This may result in the unit falling to the lower stair riser, thus interrupting a smooth and controlled descent and potentially causing damage.

The prior art attempts to address this problem associated with descent through altering the geometrical structure of the spider assembly, proposing the use of a four-wheeled spider assembly instead of a three-wheeled one, built with predetermined dimensions to suit a stairwell of typical height. Thus crafted, the pre-dimensioned four-wheel spider avoids the aforementioned problem on a typical stairwell since its central pivot locations lie forward of the pivot center of the lower leaning wheel. However, even a four-wheeled spider thus properly dimensioned will nonetheless confront the aforementioned problem on a relatively shallow stairwell outside the bounds of its geometrical design.

This invention introduces a means for engaging an alternating climb-down and climb-up oriented torque on the spider assembly during stairwell descent responsive to the absolute rotation angle of the spider, ensuring that the lead wheel is pinned properly against the inside corner of the lower stairwell, thus eliminating the possibility of unintended backward rotation, without imposing any restrictions on the geometry or dimensions of the spider wheel to suit any specific stairwell height. As a result, an advantage is gained that allows for any spiderwheel configuration, including a three-wheeled configuration, to properly descend stairwells of any riser height.

### SUMMARY OF THE INVENTION

Briefly described, the invention comprises a spider assembly that is fixed to an end of a driveshaft of a towing device comprising three equal-radii wheels arranged in the formation of an equilateral triangle. The spider assembly is driven in both directions via a motor, coupled to the main driveshaft. The motor is driven in the climb-up and climb-down directions via a control unit, such as a microprocessor, receiving input from a sensor mounted between the spider and the towing device that measures the absolute angle of rotation of the spider.

The invention will be more fully described by reference to the following drawings.

### BRIEF DESCRIPTION OF THE DRAWINGS

FIG. 1 is an isometric view of the device.

FIGS. 2(A-F) show very schematically successive steps of the device depicted in FIG. 1 negotiating stairwell descent.

FIG. 3 shows a schematic side view of the device depicted in FIG. 1 on a steep stairwell.

FIG. 4 is an operational flowchart of the device depicted in FIG. 1.

FIG. 5 shows a side-view of the device depicted in FIG. 1 traversing horizontally in a two-contact point configuration.

FIG. 6 shows a side-view of an alternative embodiment of the device with supporting stand.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

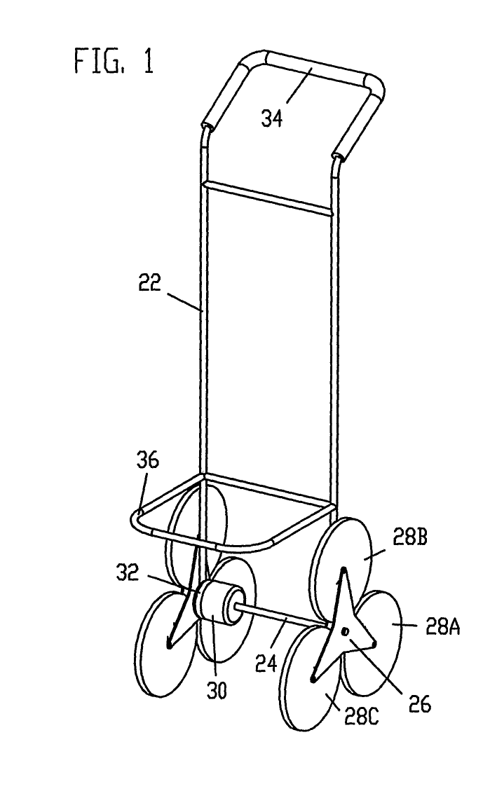

Referring initially to FIG. 1, the handtruck device consists of towing frame 22 comprising a through-going shaft 24. Symmetrically fixed to both ends of the shaft are spiderwheel assemblies comprising holding means 26 to which free-rotating wheels 28(A-C) are attached in a star like configuration. Only one of the two spiderwheel assemblies is indexed with reference numerals. A geared motor 30 is fixed to both 24 and 22 so that rotational torque may be applied to cause spiderwheel assembly to rotate in both directions along the axis parallel to 24 while 22 remains fixed. Angle sensor 32 measures the angle formed between frame 22 and spiderwheel assembly 26. User handle 34 is located at the top end of 22 while a load-bearing nose 36 is attached above spiderwheel assemblies to 22.

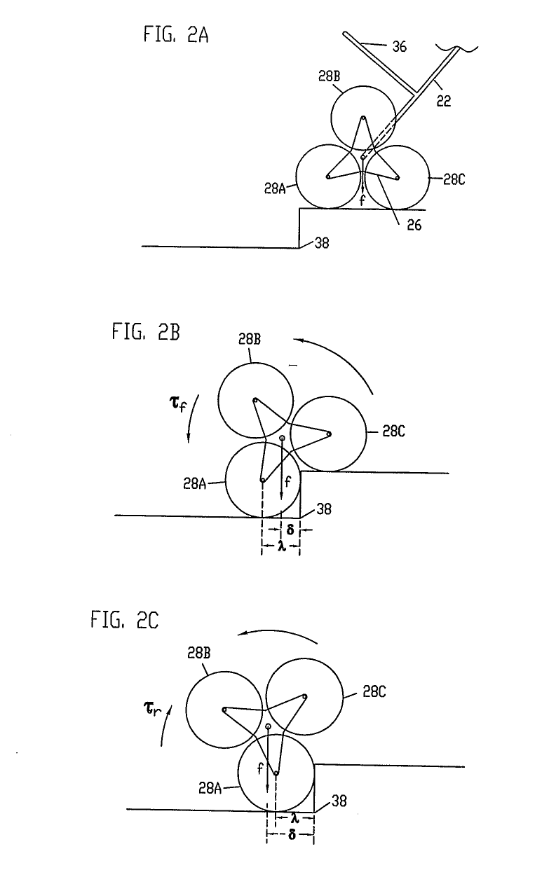

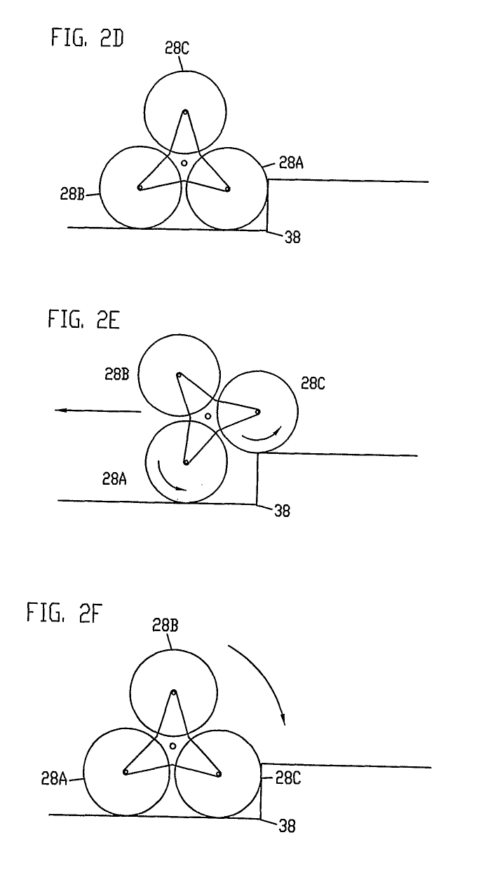

To operate the unit on horizontal surfaces and stairwells, frame 22 is inclined with respect to the horizontal at a predetermined angle as depicted in FIG. 2A with a user gripping handle 34. Weight resting on 36 produces a downward-directed force f on the center of spider assembly 26. For the purposes of illustrating spiderwheel orientation during descent, triangularly symmetric wheels 28A-C are labeled separately in FIGS. 2A-F. As depicted in FIG. 2A the unit starts on a higher riser approaching lower riser 38. Lead wheel 28A then rolls over the corner of the higher stair causing the 26 to rotate about its center until 28A makes contact with lower riser 38. As depicted in FIG. 2B horizontal distance δ as measured from the inside corner of 38 to the center of rotation of 26 is less than horizontal distance λ measured from the center of 28A to inside corner of 38 so that force f produces a clockwise-oriented moment around 26. Since δ<λ weight has not shifted appropriately to cause 26 to pivot in the climb-down direction around the center of 28A. Instead, 28A rolls forward as in FIG. 2E causing 28C to fall suddenly to 38 and the spiderwheel assembly to back turn as depicted in FIG. 2F.

To avoid this scenario, a forward torque τ_{f} is applied by the geared motor in the case that δ<λ, i.e. when the center of 26 is not horizontally to the left of the center pivot point of 28A. Since 22 is kept at a constant level of inclination with respect to the horizontal, and angle sensor 32 measures the angle formed between 22 and 26, 22 effectively measures the orientation of 26 in relation to the horizontal by transitive property. 32 is thus able to verify when the condition δ<λ holds. As τ_{f} is applied, 26 rotates counterclockwise about the central point of 28A until δ>λ as depicted in FIG. 2C. When the condition δ>λ holds, force f produces a counterclockwise-oriented moment around 28A, continuing the direction of rotation of 26. A clockwise-oriented reverse torque τᵣ is then applied in order to slow the velocity of rotation of 26 about the center of 28A. Reverse torque is applied until 26 has reached the flat orientation as depicted in FIG. 2D. Flat orientation is verified by 32. Wheel 28A remains abutting 38 while wheel 28B is forward of 28A resting on the lower riser, whereas in the alternate situation attempting to be avoided depicted in FIG. 2F, wheel 28C has fallen to about 38 while 28B does not contacting the ground. Having completed 120° of rotation, the unit is once again in the original orientation depicted in FIG. 2A, ready to travel on flat ground or descend another stair in a similar manner as described.

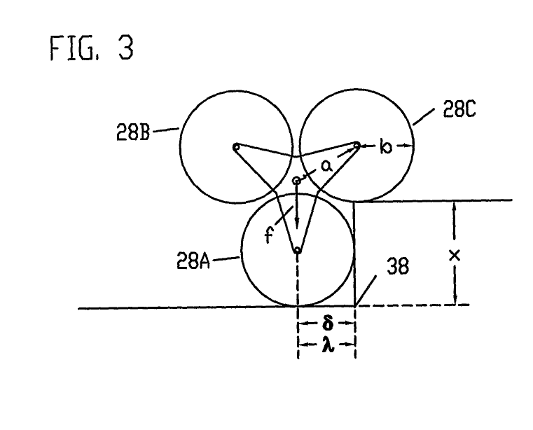

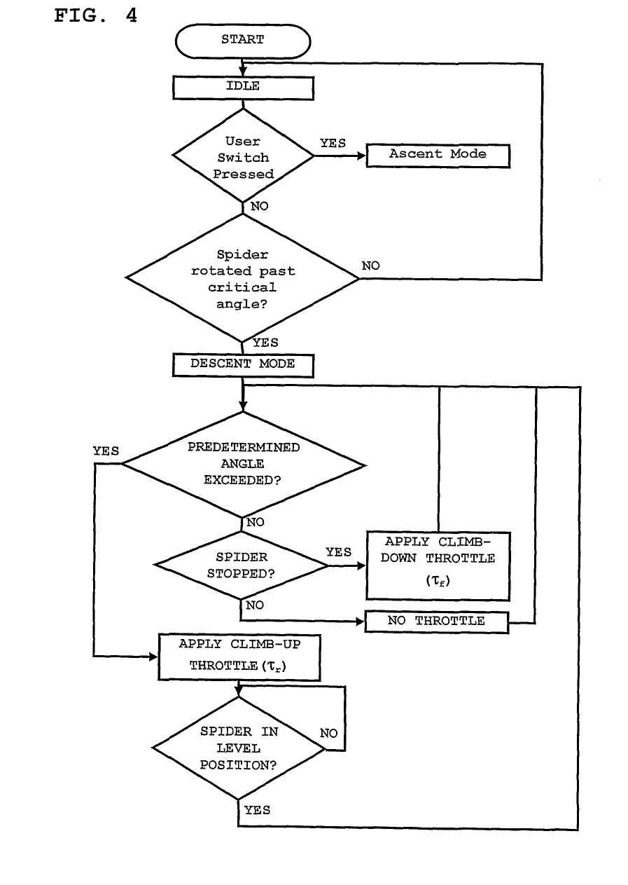

Higher stair risers may be encountered as depicted in FIG. 3 where riser height x, distance a from center of 26 to the center of each wheel, and wheel radius b satisfy the relationship: x>b+a+½a−b, or more simply, x>3/2*a. In this situation, forward torque τ_{f} need not be applied during descent since the condition δ>λ is avoided. FIG. 4 depicts the unit operation in a flowchart as previously described.

One advantage of the preferred embodiment allows for the geared motor 30 to allow for continued rotation of the spiderwheel assembly until a predetermined position is attained where at least two of the wheels 28A-C will abut a surface. In an unstable position such as that depicted in FIG. 2C where only one wheel remains abutting a surface, should the user let go of an engagement switch indicating a preference to stop mid-stairwell during ascent or descent, the microprocessor will allow for continued counterclockwise-oriented rotation until the orientation in FIG. 2D is reached, whereupon the motor applies a nominal clockwise-oriented torque to the spiderwheel, thus locking the spiderwheel in an attained position.

Individual stages of the vehicle depicting ascent up stairs are referred to in the reverse sequence FIGS. 2D-A. Referring to the spiderwheel orientation in FIG. 2C, should the user decide to disengage the trigger means for ascent, the unit appropriately continues clockwise-oriented rotation until lead wheel 28C rests on the higher riser surface as depicted in FIG. 2B, before the motor locks the unit in the attained position as previously described by applying a nominal clockwise-oriented. Thus two separate orientations as depicted in FIGS. 2B and 2D may provide stable locking positions, i.e. where two of the three wheels remain abutting a stairwell surface.

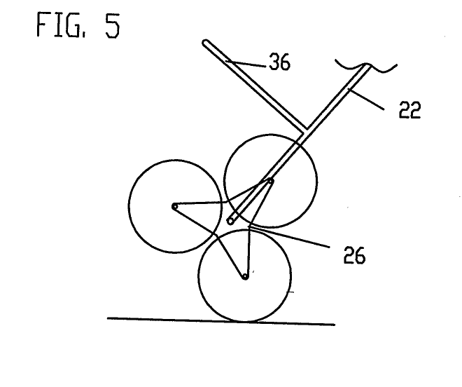

The spiderwheel may employ an optional locking mechanism such as a latch, hand brake, mechanical clutch, or electronic brake, to disallow spiderwheel rotation in relation to frame 22 when the unit is resting on a horizontal surface with the two of the three wheels resting on the ground as depicted in FIG. 1 Upon inclining frame 22 to traverse horizontal surfaces, the spider assembly and frame tilt as one fixed unit, allowing only two of the wheels to contact the ground rather than four as depicted in FIG. 5. The unit's turning radius is thus greatly reduced, enabling the turning of tight corners. The locking mechanism may then be disengaged prior to ascent and descent, allowing for the free rotation of the spider wheel as depicted in FIG. 2A.

### Advantages

Accordingly, it is the object of this invention to introduce a means to apply climb-down torque to ensure proper pinning of the lead wheel of a towing device against the inside corner of a lower riser, ensuring proper descent. In addition, several objects and advantages of this invention are:

a.) to introduce a means of braking the spider wheel assembly by applying climb-up oriented torque using said means for applying torque;

b.) to enable the locking of the spider wheel into predetermined orientations in relation to the frame during ascent and descent mid-stairwell using said means for applying torque.

c.) To enable the locking of the spider wheel in relation to the frame while traversing horizontal surfaces so as to reduce the number of ground contact, thus increasing mobility.

While the invention has been described with reference to the preferred embodiment thereof, it will be appreciated by those of ordinary skill in the art that modifications can be made to the structure and elements of the invention without departing from the spirit and scope of the invention as a whole.

### ALTERNATIVE EMBODIMENTS

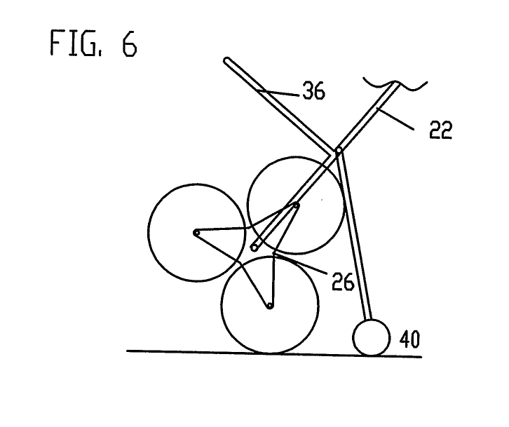

The towing frame may assume different forms, such as a baby carriage or a sack truck of similar weight-bearing capacity, with an additional set of supporting wheels located near the end of the load-bearing nose 36 to facilitate in horizontal traversal. An additional set of wheels may be attached to a support stand 40 that can swing out from frame 22 to facilitate in horizontal traversal as depicted in FIG. 6. The unit may be equipped with a load-measuring scale that interacts with the microprocessor to adjust motor output to suit varying loads.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A towing device comprising:
a user handle located at the upper end of a towing device;
a central driveshaft coupled to the lower end of a towing device;
symmetrically arranged spider assemblies coupled to opposite ends of said driveshaft;
an angle sensor mounted between said driveshaft and towing device measuring the absolute angle of rotation between the spider assembly and towing device; and
means for applying a rotational torque to said spider assembly during stairwell descent responsive to said angle sensor.

2. The apparatus of claim 1 wherein said means for applying rotational torque applies torque to the spider in the climb-up direction during stairwell descent, providing a braking force after said angle sensor verifies that the lower-leaning wheel of said spider assembly is pinned against the lower-inside corner of the lower stair

3. The apparatus of claim 2 wherein said means for applying rotational torque applies torque to the spider in the climb-down direction during stairwell descent, until said angle sensor verifies that the lower leaning wheel of said spider assembly has been pinned against lower-inside corner of the lower stairwell.

4. The apparatus of claim 1 wherein said means for applying rotational torque may lock the spider assemblies at a predetermined angle.

5. The apparatus of claim 3 wherein said means for braking may lock the spider assemblies at a predetermined angle.

6. The apparatus of claim 5 wherein said spider assembly comprises three wheels of equal radii arranged in the formation of an equilateral triangle.

7. The apparatus of claim 5 where a latch mechanism may optionally lock the spider wheel relative to the frame to enable horizontal traversal on only one of the three wheels of each spider assembly.

8. The apparatus of claim 6 where a latch mechanism may optionally lock the spider wheel relative to the frame to enable horizontal traversal on only one of the three wheels of each spider assembly.
